(19) United States
(12) Patent Application Publication
(10) Pub. No.: US 2006/0149829 A1
(43) Pub. Date: Jul. 6, 2006

(54) Monitor system

(76) Inventor: Ta-Chiun Kuan, Hsinchu County (TW)

Correspondence Address: LOWE HAUPTMAN BERNER, LLP, 1700 DIAGONAL ROAD, SUITE 300, ALEXANDRIA, VA, 22314, US

(21) Appl. No.: 11/318,832

(22) Filed: Dec. 28, 2005

(30) Foreign Application Priority Data
Dec. 31, 2004 (TW) 094100171

(51) Int. Cl. G06F 15/16

(52) U.S. Cl. 709/217

(57) ABSTRACT

This invention is directed to a monitor system (1). The monitor system includes a monitor controller (10), at least one video server (141), at least one video camera set (151), and at least one microphone (161). The monitor controller and the at least one video server are connected to different power line LAN switches, respectively, which will achieve the purpose of exchanging data via a power line LAN.

### BACKGROUND OF THE INVENTION

1. Field of the invention

The present invention relates to a monitor system, especially to a monitor system exchanging data via a power line network.

2. Description of the related arts

Monitor systems are widely applied in many occasions, such as familial safekeeping and community safekeeping, to achieve the purpose of vigilance. And, there's a great demand of the monitor systems.

One of the conventional monitor systems is closed-circuit type. This type of conventional monitor system includes a monitor controller being electrically connected to each video camera set and each microphone in the system directly by a plurality of virtual signal wires. Information captured by each video camera set and each microphone is controlled and received by the monitor controller. A user can deal with the above-mentioned information by virtue of the monitor controller to obtain reference for vigilance. However, this type of conventional monitor system need expensive equipment and cannot be expanded expediently. In addition, it is difficult and discommodious to install or setup this type of conventional monitor system.

Another conventional monitor system is open-circuit type, which enables fine expansibility. This type of conventional monitor system includes a monitor controller connected to the Internet or a local area network (LAN) via a first modem at a first end. A second modem is set at another given end for converting data information, the second modem being connected to a plurality of video camera sets and a plurality of microphones. That is to say, the connection between the monitor controller and the video camera sets and the microphones is achieved by the Internet or the LAN, which enables lower cost of line arrangement while expanding equipments, and enables expediency of installation or setup. However, the video camera sets and microphones in this conventional monitor system must be provided with line-configures for power supply, and must be provided with output-configures of network cables at the same time, which intangibly limits the requirements of installation and increases the setup cost of the monitor system. Technology of current wireless network equipment is so mature that it may be used to replace the traditional network power cables. Nevertheless, modem wireless network equipment, such as network structure of IEEE802.1 series or Bluetooth, only suits short-distance LAN. While the monitor system using the wireless network equipment is applied in a large community, a park or a large plant, the cost of installation cannot be effectively reduced all the same. Furthermore, signals transmitted in the wireless network are unstable. If the wireless network is applied in the monitor system, the monitor controller may lose the control to the video servers temporarily because of the unstable signals, which will cause dead angles of security.

### SUMMARY OF THE INVENTION

A major object of the present invention is to provide a monitor system using power line LAN to exchange related data thereof. Data exchanging between the video camera sets/microphones and the monitor controller is achieved via the power line LAN. Cost of installation is effectively reduced while the monitor system is applied in a community, a park, or a large plant.

According to the present invention, an improved monitor system is provided to resolve the disadvantages mentioned-above. The monitor system includes a monitor controller electrically connected to a first power line LAN switch, a first video server electrically connected to a second power line LAN switch, a first video camera set electrically connected to the first video server for capturing video data and transmitting the video data to the first video server, and a first microphone electrically connected to the first video server for capturing audio data and transmitting the audio data to the first video server. The first power line LAN switch is connected to the second power line LAN switch via a power line LAN for exchanging data therebetween.

According to the above-described invention, the monitor system includes a personal computer provided with monitor controlling software.

According to the above-described invention, the monitor controller is electrically connected to the first power line LAN switch by a RJ-45 power cable.

According to the above-described invention, the first video server is electrically connected to the second power line LAN switch by a RJ-45 power cable.

According to the above-described invention, the power line LAN connecting the first power line LAN switch and the second power line LAN switch contains no filter.

According to the above-described invention, the monitor system further includes a second video camera set electrically connected to the first video server for capturing video data and transmitting the video data to the first video server, and a second microphone electrically connected to the first video server for capturing audio data and transmitting the audio data to the first video server.

According to the above-described invention, the monitor system further includes a second video server electrically connected to a third power line LAN switch, a third video camera set electrically connected to the second video server for capturing video data and transmitting the video data to the second video server, and a third microphone electrically connected to the second video server for capturing audio data and transmitting the audio data to the second video server. The first power line LAN switch is connected to the third power line LAN switch via a power line LAN for exchanging data therebetween.

According to the above-described invention, the second video server is electrically connected to the third power line LAN by a RJ-45 power cable.

According to the above-described invention, the monitor system further includes a hub electrically connected between the monitor controller and the first power line LAN switch, and a modem electrically connected to the hub and connected to the Internet for exchanging data with a given position in the Internet.

According to the above-described invention, modems said above can be selected from Dial-up modems, ADSL modems, or cable modems.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

The present invention will become more apparent from the following detailed description when taken in conjunction with the accompanying drawings, in which:

### BRIEF DESCRIPTION OF THE DRAWINGS

FIG. 1 is a block-illustration of a monitor system in accordance with a first preferred embodiment of the present invention; and

FIG. 2 is a block-illustration of a monitor system in accordance with a second preferred embodiment of the present invention.

### DESCRIPTION OF PREFERRED EMBODIMENT

Reference will now be made to the drawings to describe the present invention in detail.

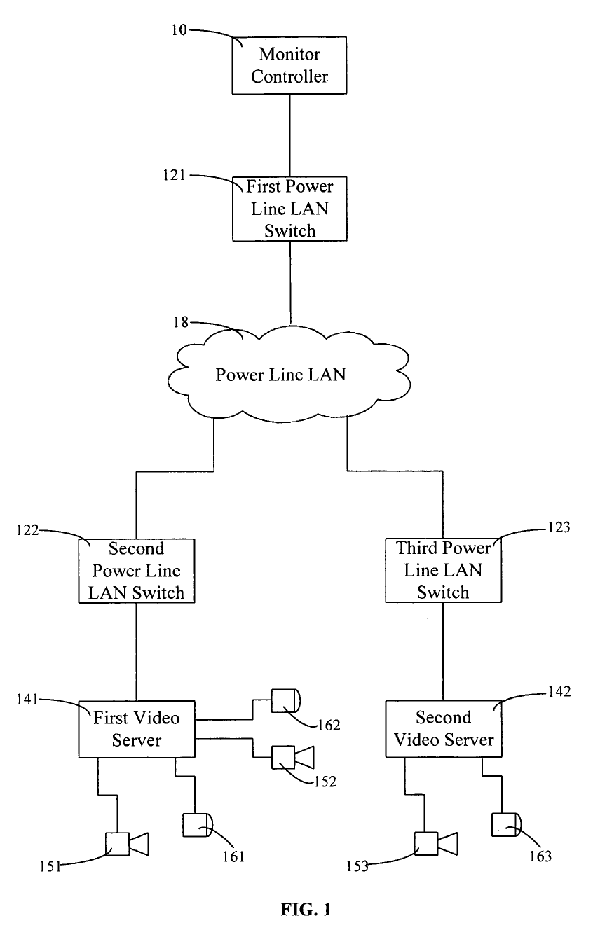

Referring to FIG. 1, which is a block-illustration of a monitor system 1 in accordance with a first preferred embodiment of the present invention, the monitor system 1 includes a monitor controller 10, at least one video server 141, at least one video camera set 151, at least one microphone 161, and at least one power line LAN switch 121. The monitor controller 10 can be a traditional monitor host or a personal computer provided with operation system and monitor controlling software. The latter enables expediency and lower cost of expanding equipment. The video server 141 is used for controlling the video camera set 151 and the microphone 161 electrically connected thereto, and is used for transmitting data to the video camera set 151 and the microphone 161. The video camera set 151 and the microphone 161 are arranged at given positions according to the requirements of installation. The video camera set 151 and the microphone 161 are electrically connected to the video server 141, respectively, which enables the video server 141 to control and receive data from the video camera set 151 and the microphone 161. Data received by the video server 141 can be converted and transmitted out by the video server 141. The video server 141 is capable of connecting more than one set of video camera set and microphone synchronously. For example, the video server 141 is capable of connecting video camera sets 151, 152, and microphones 161, 162 at the same time. If necessary, another video server 142 can be added to the system to control and receive data from a video camera set 153 and a microphone 163. Quantity of the video camera sets or the microphones is determined according to the factual requirement. Other examples of different quantity of video camera sets and microphones will no more be recited in this embodiment repeatedly.

According to the above-mentioned configuration, the monitor controller 10 must be electrically connected to a first power line LAN switch 121, and a first video server 141 should electrically connected to a second power line LAN switch 122. If necessary, a second video server 142 should be electrically connected to a third power line LAN switch 123. It is noted that the power line LAN switches 121, 122, 123 are devices that enable converting data into network packages and enable receiving or sending said packages via a power line LAN 18. Thus, controlling instructions sent out by the monitor controller 10 can be converted into network packages by the first power line LAN switch 121, and the network packages are transmitted to a given position, such as the second power line LAN switch 122 and the third power line LAN switch 123, via the power line LAN 18. The second power line LAN switch 122 and the third power line LAN switch 123 receive the network packages and then convert the packages into controlling instructions for transmitting to the first and second video servers 141, 142. The video camera sets 151, 152, 153 and the microphones 161, 162, 163 are accordingly controlled. Matter-of-course, video data captured by the video camera sets 151, 152, 153 and audio data captured by the microphones 161, 162, 163 can be received and converted into network packages by the first and second video servers 141, 142, and then the network packages are transmitted to the power line LAN 18 via the second and third power line LAN switches 122, 123, and finally the packages are received and converted into data by the first power lien LAN switch 121 for transmitting to the monitor controller 10 to handle, which achieves the purpose of exchanging data by the power line LAN 18. A user can obtain needed information from the monitor controller 10 for vigilance. In a better mode, the power line LAN 18 should contain no filter for preventing the network packages form being filtrated during the transmitting procedure.

The video camera sets 151, 152, 153 and microphones 161, 162, 163 of the above-mentioned monitor system 1 can be only provided with power lines while being installed. No additional configuration, such as a virtual signal-transmitting line or a network cable, is needed to be provided for exchanging monitor controlling data, which can observably curtail the time and manpower of installation, and can further reduce the installing cost. In addition, signals transmitted via the power line LAN can be transmitted to some place ten kilometers away. Therefore, the monitor system 1 of the present invention suits communities or large plants. The more large the application occasion is, the more prominent the deduction of lines and difficulties shows. Also, the cost of installation and settling is reduced more prominently. For example, while the monitor system is applied in a large community, video camera sets and microphones thereof can be arranged on street lamps along the roads, which enables the data to be transmitted to the monitor controller via the power lines originally used by the lamps. This example shows the advantage of the present invention on installation.

An input port of a generic power line LAN switch is matchable to a RJ-45 cable plug, at the same time, a generic video server provides a RJ-45 cable plug, which makes the connection between the power line LAN switch and the video server more easier. The cost for connecting the power line LAN switch and the video server is also very low. Indeed, the monitor controller and the first power line LAN switch can be simultaneously arranged on one printed circuit board for obtaining a function-combined equipment, which enables lower cost and more convenient usage. For the same reason, the first video server and the second power line LAN switch can be also simultaneously arranged on one printed circuit board, while the second video server and the third power line LAN switch can be also simultaneously arranged on one printed circuit board. In addition, the video camera sets and the microphones only need to be connected to power lines, which enables to reduce other complex arrangement of cables and enables to beautify the appearance of the system after installation. All these can further satisfy the users' requirements.

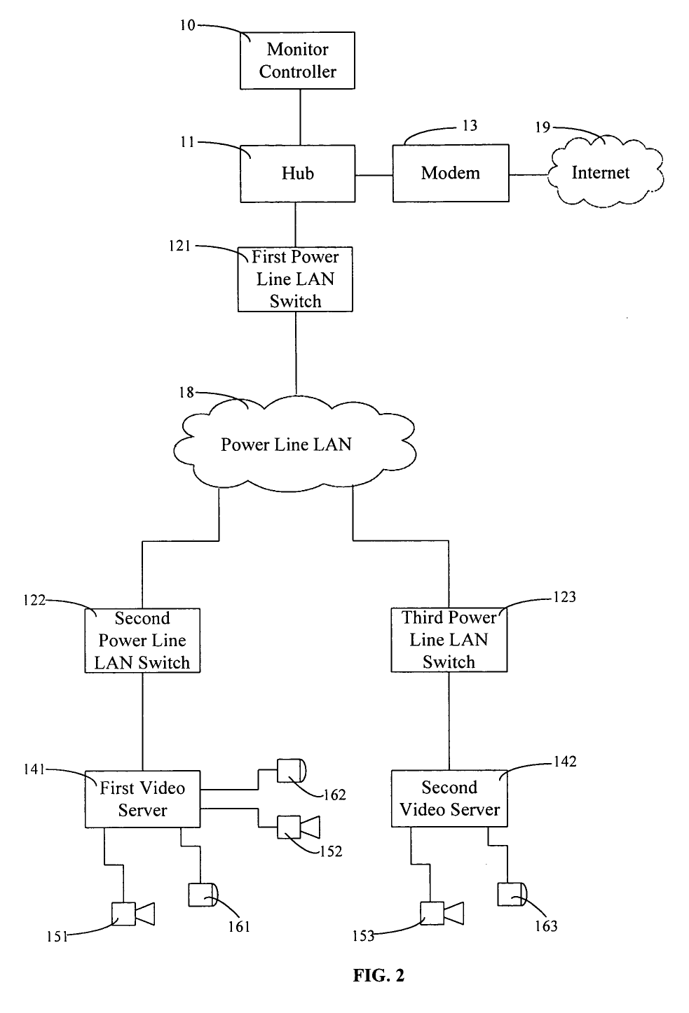

FIG. 2 is a block-illustration of a monitor system in accordance with a second preferred embodiment of the present invention. The monitor system 1′ comprises all the elements described in the first preferred embodiment and further includes a hub 11 connected between the monitor controller 10 and the first power line LAN switch 121. The hub 11 is further connected to a modem 13. Therefore, the monitor system 1 can be connected to the Internet 19. According to the settings of the monitor controller 10, controlling instructions or data from the monitor controller 10 can be converted to network packages by the modem 13 and can be then uploaded to given positions in the Internet 19. The networks uploaded to the Internet 19 can be received and converted by another modem (not shown) for being dealing with or being applied, such as for controlling other video servers (not shown) or another monitor controller (not shown). Thus, other purposes of controlling or data exchanging are accordingly achieved. The modem 13 cited above can be selected form dial-up modems, ADSL modems or cable modems.

According to the disclosure above, it is known that the monitor systems of the present invention have excellent elasticity of function-expansion without adding complex equipment, which can proof that the present invention is emulative and useful.

Furthermore, although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A monitor system comprising:
a monitor controller, electrically connected to a first power line LAN switch;
a first video server, electrically connected to a second power lien LAN switch;
a first video camera set electrically connected to the first video server for capturing video data and transmitting to the first video server; and
a first microphone electrically connected to the first video server for capturing audio data and transmitting to the first video server; wherein
the first power line LAN switch is connected to the second power line LAN switch via a power line LAN for exchanging data therebetween.

2. The monitor system as described in claim 1, wherein the monitor controller is a personal computer provided with monitor controlling software.

3. The monitor system as described in claim 1, wherein the monitor controller and the first power line LAN switch are defined on one printed circuit board.

4. The monitor system as described in claim 1, wherein the monitor controller is electrically connected to the first power line LAN switch by a RJ-45 power cable.

5. The monitor system as described in claim 1, wherein the first video server and the second power line LAN switch are defined on one printed circuit board.

6. The monitor system as described in claim 1, wherein the first video server is electrically connected to the second power line LAN switch by a RJ-45 power cable.

7. The monitor system as described in claim 1, wherein the power line LAN contains no filter.

8. The monitor system as described in claim 1 further comprising a second video camera set electrically connected to the first video server for capturing video data and transmitting to the first video server, and a second microphone electrically connected to the first video server for capturing audio data and transmitting to the first video server.

9. The monitor system as described in claim 1 further comprising:
a second video server electrically connected to a third power lien LAN switch;
a third video camera set electrically connected to the second video server for capturing video data and transmitting to the second video server; and
a third microphone electrically connected to the second video server for capturing audio data and transmitting to the second video server; wherein
the first power line LAN switch is connected to the third power line LAN switch via a power line LAN for exchanging data therebetween.

10. The monitor system as described in claim 9, wherein the second video server and the third power line LAN switch are defined on one printed circuit board.

11. The monitor system as described in claim 9, wherein the second video server is electrically connected to the third power line LAN switch by a RJ-45 power cable.

12. The monitor system as described in claim 1 further comprising:
a hub, electrically connected between the monitor controller and the first power line LAN switch;
a modem, electrically connected to the hub and connected to the Internet for exchanging data with a given position in the Internet.

13. The monitor system as described in claim 12, wherein the modem is selected from one of dial-up modems, ADSL modems or cable modems.
